(19) United States
(12) Patent Application Publication
(10) Pub. No.: US 2006/0198964 A1
(43) Pub. Date: Sep. 7, 2006

(54) Method for the inkjet varnishing of a print

(75) Inventor: Michael Kaiser, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/370,383

(22) Filed: Mar. 6, 2006

(30) Foreign Application Priority Data
Mar. 4, 2005 (DE) 10 2005 010 304.9

(51) Int. Cl. C08F 2/46

(52) U.S. Cl. 427/487

(57) ABSTRACT

A method for the inkjet varnishing of a print permits controlled adjustment of the level of gloss. Varnish droplets are ejected onto the surface of the print from the inkjet in a screen or half-dot pattern. Use may be made of a UV varnish which, after the ejection of the varnish droplets, is exposed to short-wave UV radiation, thus starting polymerization of the surface of the UV varnish.

### BACKGROUND OF THE INVENTION

### Field of the Invention

The invention relates to a method for the inkjet varnishing of a print.

It is known to apply areas of effect varnishing to a print produced by offset printing by using an inkjet printing device. If UV varnishes are ejected from the nozzles of the inkjet printing device, then the result is a thick varnish film, which leads to a smooth and glossy surface irrespective of the surface structure of a printing material. A high level of gloss is not desired in every case.

In the case of prior art inkjet printing devices, the volume of varnish which can be ejected from the nozzles per unit time is limited by the design, so that an application of varnish over the entire area is not possible at a high printing speed. For full-area varnishing, the number of nozzles can be increased, it being necessary to expect higher costs and a larger overall space. A further possibility for full-area varnishing consists in repeat overvarnishing with a few nozzles present, which increases the varnishing time. In the case of inkjet printing devices having a low resolution, the undesired formation of lines occurs if, at a high printing speed, the time between varnishing application and curing is too short. Lengthening the distance in order to cure the varnish thoroughly increases the overall space of the inkjet printing device.

U.S. Pat. No. 6,608,987 B2 and its counterpart German patent DE 100 64 552 B4 disclose a method for coating a substrate wherein the gloss of a toner image is adjusted by controlled heating of the UV-curing toner. Slow curing of the toner leads to an even, glossy surface. Short heating leads to an uneven, matt surface. By means of the adjustment of the level of fusing in combination with control of the time at which a crosslinking or curing process is initiated, the level of gloss can be influenced within certain limits.

In a method for producing different levels of gloss on printing materials according to U.S. Pat. No. 6,637,338 B2 and its counterpart German published patent application DE 100 57 642 A1, at least two different ink systems are used to produce a printed image, which change the level of gloss specifically in interaction with a varnish layer. For example, the ink systems can also exhibit a different absorption capacity with respect to the varnish.

### SUMMARY OF THE INVENTION

It is accordingly an object of the invention to provide a method of varnishing a print with an ink jet device which overcomes the above-mentioned disadvantages of the heretofore-known devices and methods of this general type and which further permits a controlled adjustment of the level of gloss.

With the foregoing and other objects in view there is provided, in accordance with the invention, a method for inkjet varnishing of a print, which comprises:

ejecting varnish droplets from an inkjet onto a surface of the print, and thereby ejecting the varnish droplets in a screen pattern.

In accordance with an added feature of the invention, UV varnish is used and, after ejecting the UV varnish droplets, the varnish is exposed to short-wave UV radiation, for initiating a polymerization of a surface of the UV varnish. Preferably, following an irradiation with short-wave UV light, the UV varnish is exposed to long-wave UV radiation for curing the varnish.

In accordance with a further feature of the invention, a time period between irradiation with the short-wave UV light and with the long-wave UV light is set to achieve a defined level of gloss of the UV varnish.

In accordance with a concomitant feature of the invention, a screen is applied to the print at an angle not equal to 90 degrees with respect to a conveying direction of a printing material. For example, the angle may be chosen to be 45 degrees.

In other words, the objects of the invention are achieved in that the varnish is printed as a half-dot or screened area. This makes it possible to reduce the amount of varnish per unit area. With the aid of a frequency-modulated or amplitude-modulated screen, a disruptive line structure can be avoided. Depending on the flow behavior of the varnish used, in the case of a screened application of varnish, a glossy or matt varnish film can be produced. In order to apply the screened varnish layer, an inkjet printing device which prints a sheet or a web over the entire area in one pass is suitable.

In order to produce a highly glossy surface, a free-flowing UV varnish is used, which levels itself between the time of application to a print and the time of complete curing. The individual varnish droplets flow into one another.

If a matt surface is to be produced, a slow-flowing UV varnish is used, which does not level itself between the time of application and the time of complete curing. The regions with a lot of varnish and no varnish, predefined by the screen, cannot equalize in the short time between the application and the curing. Depending on the properties of the screen, a surface structure is formed which scatters the incident light diffusely. A varnish screen produced with high resolution results in a uniform structure which is perceived by the human eye as a matt surface. The resolution is chosen to be sufficiently high that no disruptive line formation occurs.

Other features which are considered as characteristic for the invention are set forth in the appended claims.

Although the invention is illustrated and described herein as embodied in a method for the inkjet varnishing of a print, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1A and 1B are schematic side elevational views showing a full-area varnish application with high resolution according to the prior art;

FIG. 1C is a plan view of the varnish application according to the prior art;

FIGS. 2A and 2B are schematic side elevational views showing a full-area varnish application with low resolution according to the prior art;

FIG. 2C is a plan view of the varnish application according to the prior art;

FIGS. 3A and 3B are schematic side elevational views showing a screened varnish application according to the invention with high resolution and slow-flowing varnish;

FIG. 3C is a plan view of the varnish application according to the invention;

FIGS. 4A and 4B are schematic side elevational views showing a screened varnish application according to the invention with high resolution and fast-flowing varnish; and

FIG. 4C is a plan view thereof.

### DESCRIPTION OF THE PREFERRED EMBODIMENTS

For the purpose of inkjet varnishing, use is made of an inkjet varnishing device which has a large number of nozzles over a width b of a region 1 to be varnished. The nozzles are arranged transversely with respect to the transport direction 2 of a printing material 3, without gaps and at equal spacing distance or intervals. The nozzles are connected to a varnish supply system. The nozzles can be driven individually by a control device. If a nozzle is driven digitally, at least one varnish droplet is ejected onto the surface of the printing material. The nozzles are driven at a fixed cycle rate, so that each nozzle ejects varnish droplets along a line which lies parallel to the transport direction 2 of the printing material 3. Given uniform displacement of the printing material 3 along the transport direction 2, a screen or grid pattern of varnish dots 4 is produced on the surface of the printing material 3. The highest resolution of the screen transversely with respect to the transport direction 2 is given by the distance between two adjacent nozzles or the number of nozzles per unit length. An inkjet printing device used to carry out the method according to the invention has a resolution of typically 236 to 284 lines/cm transversely with respect to the transport direction 2. The resolution in the transport direction 2 is given by the number of varnish dots 4 produced in each index advance distance produced in the transport direction 2. The resolution in the transport direction 2 is set as high as that transversely with respect to the transport direction 2.

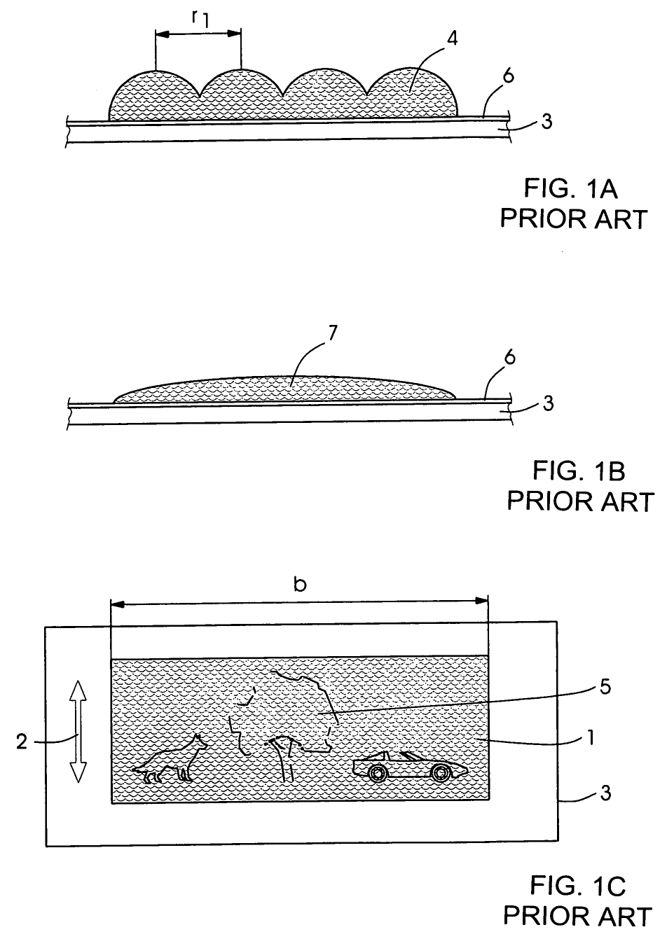

Referring now more specifically to FIGS. 1A-1C, there is shown a full-area varnish application with high resolution according to the prior art. A sheet 3 has a multicolored printed image 5 produced by sheet-fed offset printing. The printed image 5 is produced by overprinting a plurality of color separated, screened images. Each partial colored image has a screen fineness of typically 60 to 120 lines/cm. In order to avoid moiré patterns or artifacts, the screens of the color-separated images are at a predefined angle in relation to one another. The printed image 5 has been overvarnished in a region 1 in a conventional varnishing unit with the aid of a halftone varnishing plate.

In a greatly enlarged illustration according to FIG. 1A, four varnish dots 4 are illustrated over an ink layer 6 of the printed image 5 on the sheet 3. The varnish dots 4 have a screen fineness r₁ in the range between 236 and 284 lines/cm in the transport direction 2 and transversely with respect thereto. Immediately after the application, the varnish droplets 4 still have a spherical surface structure. If the sheet 3 is conveyed to a curing station after the varnish application, the varnish dots 4 flow into one another, as illustrated in FIG. 1B, depending on the varnish viscosity. Following curing with a UV light source, the result is a closed varnish film 7 having a smooth surface free of stripes.

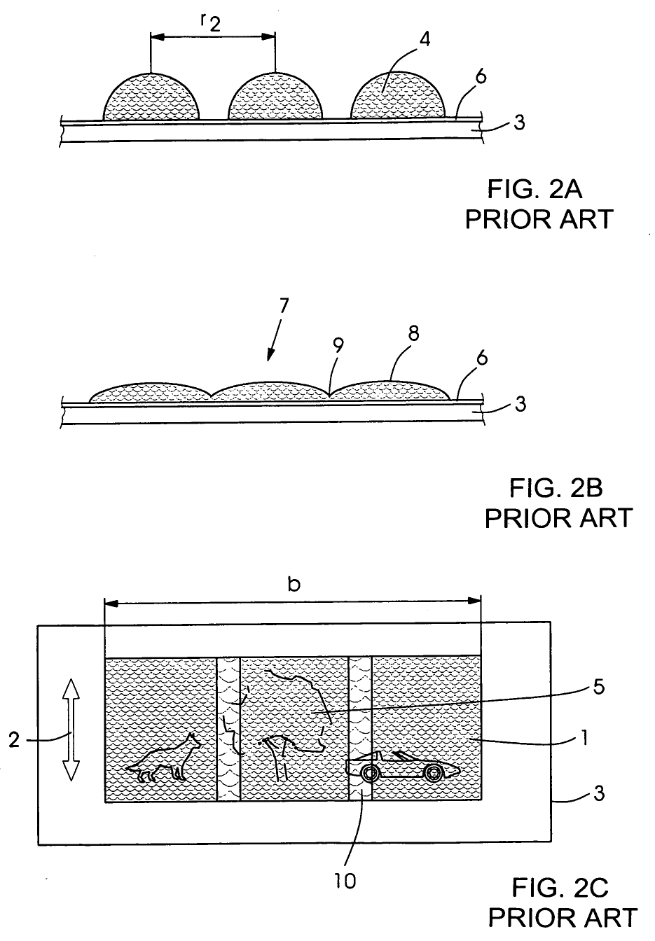

If the screen fineness of the varnishing plate is reduced, the result is the situation illustrated in FIGS. 2A-2C. The varnish dots 4 illustrated in FIG. 2A have an increased screen spacing r₂ in the range between 118 lines/cm and 142 lines/cm. As described in relation to FIG. 1.2, the varnish dots flow into one another on the way to the curing station, peaks 8 and valleys 9 remaining in the varnish film 7, as illustrated in FIG. 2B. FIG. 2C shows a view of the varnished region 1 on the sheet 3. The valleys 9 are visible as stripes 10 in the varnish surface. This is not desireable.

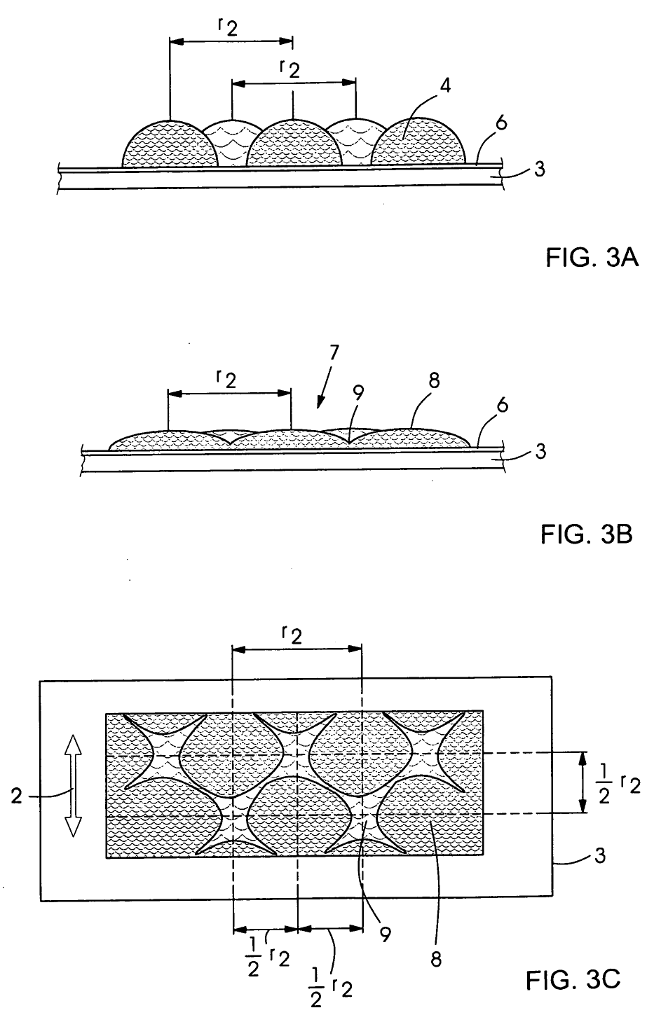

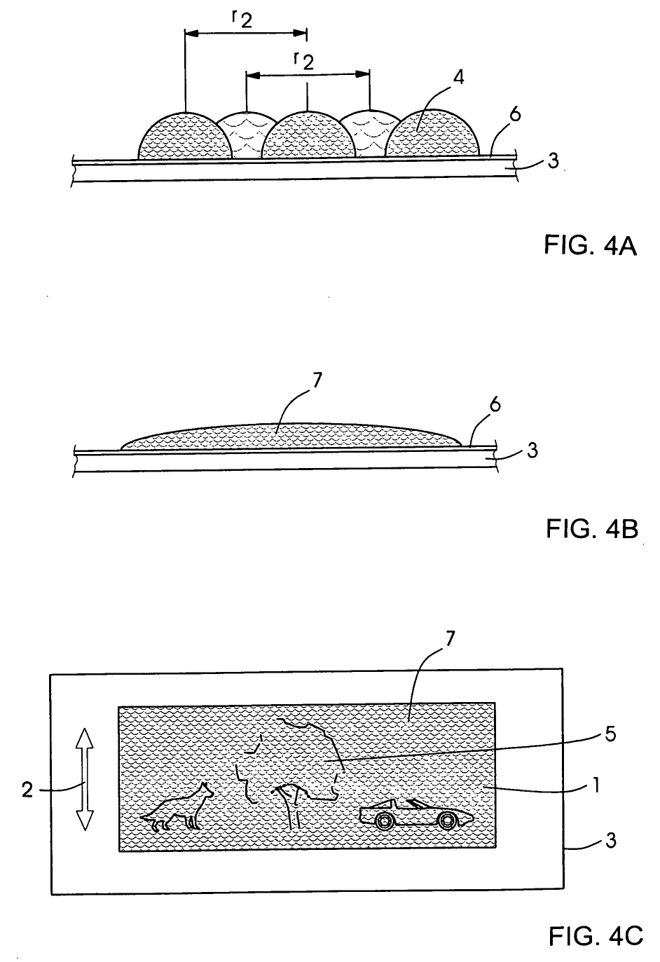

The performance of the method according to the invention will be described reference to FIGS. 3 and 4. FIG. 3A shows five varnish dots 4 immediately at the time following the ejection of the varnish droplets out of the nozzles of an inkjet printing device. Transversely with respect to the transport direction 2 of a sheet 3, the varnish dots 4 lying at one height have the screen spacing r₂. The varnish dots 4 are arranged line by line offset by % r₂ in relation to one another. In order to produce a surface with a matt finish, a slow-flowing UV varnish is used. On the way to a UV curing station, the varnish dots 4 flow into one another. After the curing with UV light, peaks 8 and valleys 9 remain, which is illustrated in FIGS. 3B and 3C. As can be seen in the plan view according to FIG. 3C, light is scattered diffusely in the valleys 9, so that the varnish surface has a non-gloss, matt appearance.

In order to produce a stripe-free, smooth and highly glossy surface, a fast-flowing UV varnish is used. As FIG. 4A reveals, the varnish dots 4 are applied over an ink layer 6 line by line with a screen spacing r₂ transversely with respect to the transport direction 2 and offset by half a screen spacing. As a result of the low viscosity of the UV varnish, the varnish dots 4 flow into one another, as illustrated in FIG. 4B, so that no peaks and valleys remain. Following the UV curing, the result is an even, unstructured varnish surface, which reflects incident light well.

This application claims the priority, under 35 U.S.C. § 119, of German patent application No. 10 2005 010 304.9, filed Mar. 4, 2005; the entire disclosure of the prior application is herewith incorporated by reference.

I claim:

1. A method for inkjet varnishing of a print, which comprises:
ejecting varnish droplets from an inkjet onto a surface of the print, and thereby ejecting the varnish droplets in a screen pattern.

2. The method according to claim 1, which comprises providing UV varnish and ejecting UV varnish droplets and, after ejecting the UV varnish droplets, exposing the varnish to short-wave UV radiation, for initiating a polymerization of a surface of the UV varnish.

3. The method according to claim 2, which comprises, following an irradiation with short-wave UV light, exposing the UV varnish to long-wave UV radiation for curing the varnish.

4. The method according to claim 3, which comprises adjusting a time period between irradiation with the short-wave UV light and with the long-wave UV light to achieve a defined level of gloss of the UV varnish.

5. The method according to claim 1, which comprises applying a screen to the print at an angle not equal to 90 degrees with respect to a conveying direction of a printing material.

6. The method according to claim 5, which comprises applying the screen at an angle of 45 degrees.
